(19) United States
(12) Patent Application Publication
(10) Pub. No.: US 2001/0042240 A1
(43) Pub. Date: Nov. 15, 2001

(54) Source code cross referencing tool, B-tree and method of maintaining a B-tree

(75) Inventors: Kai Ng, Nepean (CA); Michael J. Garvin, Nepean (CA)

Correspondence Address: SMART AND BIGGAR, 438 UNIVERSITY AVENUE, SUITE 1500 BOX 111, TORONTO, ON, M5G2K8, CA

(73) Assignee: NORTEL NETWORKS LIMITED

(21) Appl. No.: 09/745,411

(22) Filed: Dec. 26, 2000

(30) Foreign Application Priority Data
Dec. 30, 1999 (CA) 2,293,167

(51) Int. Cl. G06F 9/44

(52) U.S. Cl. 717/3

(57) ABSTRACT

A method and tool for storing source-code cross referencing information is disclosed. The source-code cross referencing information is stored within a B-tree. Preferably only global cross-reference information is contained within the B-tree. Records within the B-tree contain information about occurrences of variables within the source code. Keyed records of data are preferably stored within leaves of a B-tree having nodes of fixed size, with multiple records of varying size potentially stored within each leaf node. Records within each leaf node are preferably indexed by indexes stored within the node. Such a B-tree may be stored within a file on a computer readable medium such as a disk. Techniques of splitting nodes in the tree are also disclosed. Further, various techniques of extracting information from a formed B-tree are disclosed.

### FIELD OF THE INVENTION:

The present invention relates to computerized data storage, and more particularly to source code cross referencing tools, B-trees and methods of maintaining such trees.

### BACKGROUND OF THE INVENTION

Many computer software applications require that data be organized for easy searching and retrieval. Databases, for example, index data records for easy retrieval. Thus, many techniques for organizing and indexing data are known.

Similarly, programmers often need to know particulars about source code they are or have created. Such particulars, typically include information about variables (ie. functions, integers, arrays, long words, etc.)and their occurrences within the source code. Thus, many source code navigational tools are known. Source code cross-referencing information may be considered as global or local. Global source code cross-referencing information identifies a file within a group of source code files containing the variable of interest. Global source code cross-reference information may further identify the type of occurrence of a variable within a file (eg. variable definition; function invocation; or the like). Local source code cross reference information, on the other hand, may identify where (ie. line number) within a file a variable occurs.

Data may be stored in a desired order in a linked list. As data is added, links may be added at the appropriate locations within the list. Alternatively, indices associated with the actual data may be stored in an ordered fashion.

One known way to arrange data for easy ordering and searching, is to store data in a B-tree. B-Trees, generally, are discussed in “An Introduction to Database Systems”, 5th Ed. C. J. Date, Addison Wesley, 1990; “Data Structures Using C”, Aaron M. Tenenbaum, Yedidyah Langsam, Moshe J. Augenstein, Prentice Hall, 1990; “Algorithms in C”, Robert Sedgewick, Addison Wesley, 1990; “Data Structures, Algorithms, and Performance”, Derick Wood, Addison Wesley, 1993; “Handbook of Algorithms and Data Structures: in Pascal and C”, 2nd Ed.; G. H. Gonnet, R. Baeza-Yates, 1991, the contents of all of which are hereby incorporated by reference.

B-trees typically include a plurality of nodes. Non-terminal nodes (often referred to as branch nodes) index terminal nodes (referred to as leaf nodes). Access to data stored within the nodes is accomplished by traversing the nodes.

Typically each node within a B-tree is a fixed size and stores a single data item. B-trees are therefore well suited to store indices for existing data. Typically, each item of data is uniquely indexed within a B-tree. B-trees are therefore often used in association with relational databases. Alternatively, while not typical, B-trees may be used to store actual data. In this arrangement, each record of data typically occupies a single node within the B-tree. Alternatively, multiple records having a fixed size may stored within a single node.

Source code navigational tools typically form cross reference information as it is required, or store complete cross-reference information within known databases. This leads to inefficient cross-referencing. B-trees may be used to store cross-reference information, however if such B-trees are used to store global and local cross-reference information for a large number of source code files with many lines, they can become extremely large and quickly unmanageable.

Accordingly, a source code cross-referencing tool that allows indexing and storage of source code information for source code having many lines, typically organized in many files is desirable. As well, a B-tree and a method of maintaining such a B-tree that facilitates storage of such information is desirable.

### SUMMARY OF THE INVENTION

In accordance with an aspect of the present invention, source-code cross referencing information is stored in a B-tree. Preferably only global cross-reference information is contained within the B-tree. Records within the B-tree contain information about occurrences of variables within the source code.

In accordance with an aspect of the invention, keyed records of data are preferably stored within leaves of a B-tree having nodes of fixed size, with multiple records of varying size potentially stored within each leaf node. Records within each leaf node are preferably indexed by indexes stored within the node. Such a B-tree may be stored within a file on a computer readable medium such as a disk. Preferably, each node has a fixed size, exactly the size of a page within the file. As such, disk access is reduced, as accessing each node requires accessing a single page within the file. Additionally, various techniques of splitting nodes in the tree can be used to limit the height of the tree.

In accordance with an aspect of the present invention, there is provided a method of adding a record to a leaf node of a B-tree having a plurality of leaf nodes storing data organized in records. Each of the leaf nodes contains at least one record and a corresponding number of indexes with each of said indexes indexing an associated record within the leaf node, and a pointer to at least one adjacent leaf node within said B-tree. The method includes determining if an adjacent leaf node has sufficient space to accommodate an existing record from the leaf node. If the adjacent leaf node has sufficient space, the existing record and index associated with the existing record are moved from the leaf node to the adjacent leaf node, thereby increasing space for adding the record to the leaf node.

In accordance with another aspect of the present invention, there is provided computer readable memory storing a B-tree. The B-tree includes a plurality of leaf nodes, each storing data in records. Each of the leaf nodes includes a data area storing the records, and an index area storing corresponding indices for the records within the data area. Each index indexes one record within the data area. The records may be ordered by re-ordering the indices within the index area.

In accordance with yet another aspect of the present invention, there is provided computer readable memory storing a B-tree. The B-tree includes at least one leaf node storing data in records. Each of the records is associated with a key. Records associated with identical keys are stored as linked lists within the leaf node.

In accordance with yet another aspect of the present invention, there is provided a method of storing an oversize record in a B-tree, having leaf nodes of a maximum size for storing records. The oversize record has a size in excess of the maximum size. The method includes creating an additional node, linked to one of the leaf nodes and storing the oversize record at least partially in one of the leaf nodes and the additional node.

In accordance with yet another aspect of the present invention, there is provided a method of splitting a leaf node within a B-tree storing records each associated with a key, in order to insert a record having a size in excess of a defined threshold. The method includes assessing a plurality of split locations within a range of keys within the tree to locate a shortest length key within the range and splitting the node at the shortest length key.

In accordance with yet another aspect of the present invention, there is provided a method of splitting a leaf node within a B-tree storing a plurality of ordered records, to insert an additional record having a size in excess of a defined threshold, at an insertion location within the node. The method includes determining the insertion location within the node as if the node had capacity to store the additional record. If the additional record is to be inserted near a beginning of the node, the node is split after the insertion location to form two formed nodes. One of the formed nodes contains all records in the node prior to the insertion location; the other contains all records after the insertion location.

In accordance with yet another aspect of the present invention, there is provided a method of splitting a node within a B-tree, in order to insert a record having a size in excess of a defined threshold, at an insertion location within the node. The method includes determining the insertion location within the node as if the node had capacity to store the additional record. If the record is to be inserted near an end of a storage area within the node, the node is split before the insertion location to form two formed nodes, with one of the formed nodes containing all records in the node prior to the insertion location, and one of the formed nodes containing all records after the insertion location.

In accordance with yet another aspect of the present invention, there is provided a method of splitting a leaf node within a B-tree, having a data area storing a plurality of records, each of the records associated with a key, in order to insert a record associated with a particular key already associated with one of the records in the node. The method includes splitting the node before a first record associated with the particular key to form two formed nodes, with one of the formed nodes containing all records in the node prior to the first record associated with the particular key. The other contains all records after the insertion location, including all records associated with the particular key.

In accordance with yet another aspect of the present invention, there is provided computer readable medium storing computer executable software adapting a computing device to split a leaf nodes within a B-tree stored at the computing device. The B-tree includes a plurality of leaf nodes storing data organized in records. Each of the leaf nodes contains a pointer to at least one adjacent leaf node within the tree. The software adapts the computer to determine if an adjacent leaf node has sufficient space to accommodate a record from the leaf node and if the adjacent leaf node has sufficient space, move an existing record from the leaf node to the adjacent leaf node. This increases space for adding the record to the leaf node.

In accordance with yet another aspect of the present invention, there is provided a method of forming a source code cross reference index for source code stored in at least one source code file. The method includes for a variable used in the source code, forming at least one record, the record containing information about an occurrence of the variable within the source code; storing the record within a node of a B-tree.

In accordance with yet another aspect of the present invention, there is provided a software product for forming a source code cross reference index for source code stored in at least one source code file, including computer readable instructions adapting a computing device to form at least one record for a variable used in the source code, and store this record within a node of a B-tree. The record contains information about an occurrence of the variable within the source code.

In accordance with yet another aspect of the present invention, there is provided computer readable memory storing a B-tree. The B-tree includes a plurality of leaf nodes, each storing data in records. Each record contains information about an occurrence of a variable within a plurality of source code files.

Other aspects and features of the present invention will become apparent to those of ordinary skill in the art, upon review of the following description of specific embodiments of the invention in conjunction with the accompanying figures.

### BRIEF DESCRIPTION OF THE DRAWINGS

In figures which illustrate, by way of example only, preferred embodiments of the invention,

FIG. 1 illustrates a computing device storing an indexing tool and index, exemplary of an embodiment of the present invention;

FIG. 2 illustrates an index in the form of a B-tree, exemplary of an embodiment of the present invention;

FIG. 3 illustrates an exemplary organization of a file used to store the B-tree of FIG. 2;

FIG. 4 illustrates an exemplary organization of a portion of the file of FIG. 3;

FIG. 5 illustrates an exemplary organization of a branch node of the B-tree of FIG. 2;

FIG. 6 illustrates an exemplary organization of a leaf node of the B-tree of FIG. 2;

FIG. 7 illustrates an exemplary organization of a portion of nodes illustrated in FIGS. 5 and 6;

FIG. 8A illustrates an exemplary parsed source code data to be added to the index of FIG. 2;

FIG. 8B illustrates an exemplary organization of a record to be added to leaf nodes of the B-tree of FIG. 2;

FIGS. 9A-9E schematically illustrate the formation of a B-tree, exemplary of an embodiment of the present invention;

FIG. 10 is a flow chart illustrating the splitting of a node within a B-tree;

FIG. 11A-11C are a flow chart illustrating the insertion of a data record within a B-tree in a manner exemplary of the present invention;

FIG. 12A illustrates an exemplary storage of records of the same key within a node of FIG. 2;

FIG. 12B schematically illustrates an exemplary leaf node of a B-tree storing records with duplicate keys;

FIG. 13 schematically illustrates deletion of records from a node of the index of FIG. 2;

FIG. 14 is a flow chart illustrating the steps used to traverse a B-tree of FIG. 2;

FIG. 15 schematically illustrates traversal of a B-tree of FIG. 2;

### DETAILED DESCRIPTION

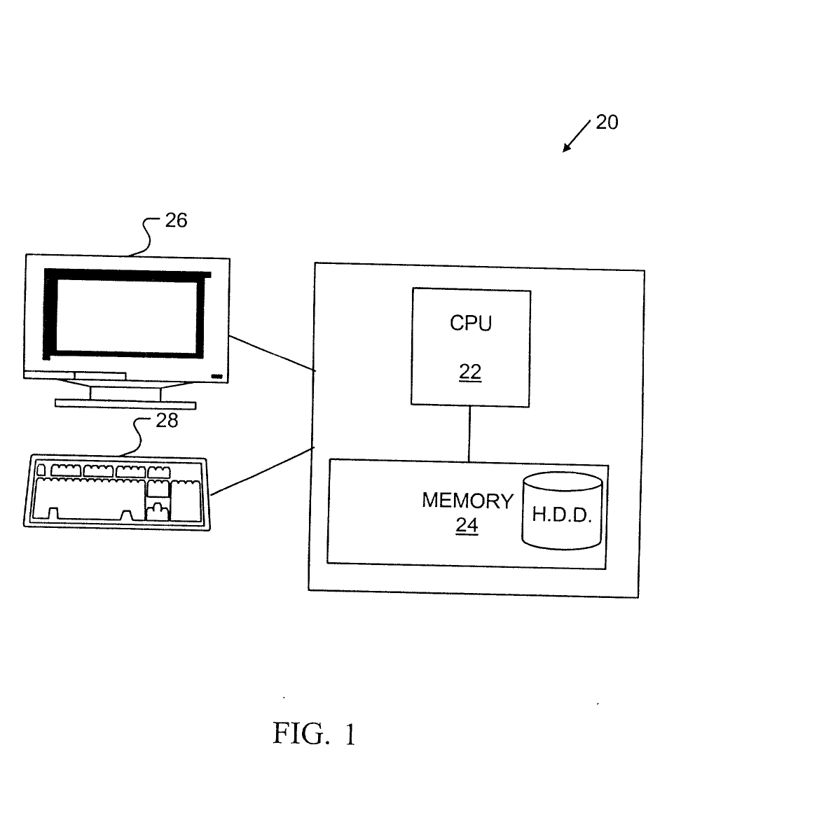

FIG. 1 illustrates a general purpose computer 20, that may be used to store a B-tree and execute software maintaining B-tree 30, exemplary of the present invention. Preferably, the software used to form and maintain B-tree 30 will be a software source code cross-referencing tool, exemplary of an embodiment of the present invention. Computer 20, may be a conventional UNIX based computing device. Computer 20 accordingly preferably includes a general purpose processor 22 in communication with processor readable memory 24, output peripheral 26, and input device 28. As understood by those of ordinary skill in the art, general purpose processor 22 may be an INTEL ×86 microprocessor, SUN Sparc processor, or the like. Memory 24 may be any suitable combination of random access memory (“RAM”); read-only memory; persistent storage memory such as a hard disk drive; removable memory in the form of a diskette, CD-ROM, DVD or the like. Output peripheral 26 may be a display interconnected with a display driver (not illustrated) in communication with processor 22. Input device 28 may include a keyboard, mouse, or similar component. As well, computer 20 may include a network interface (not illustrated) through which software or data exemplary of the present invention may be loaded by way of a computer network. Application and operating system software controlling the operation of processes 22 may be stored within portions of memory 24.

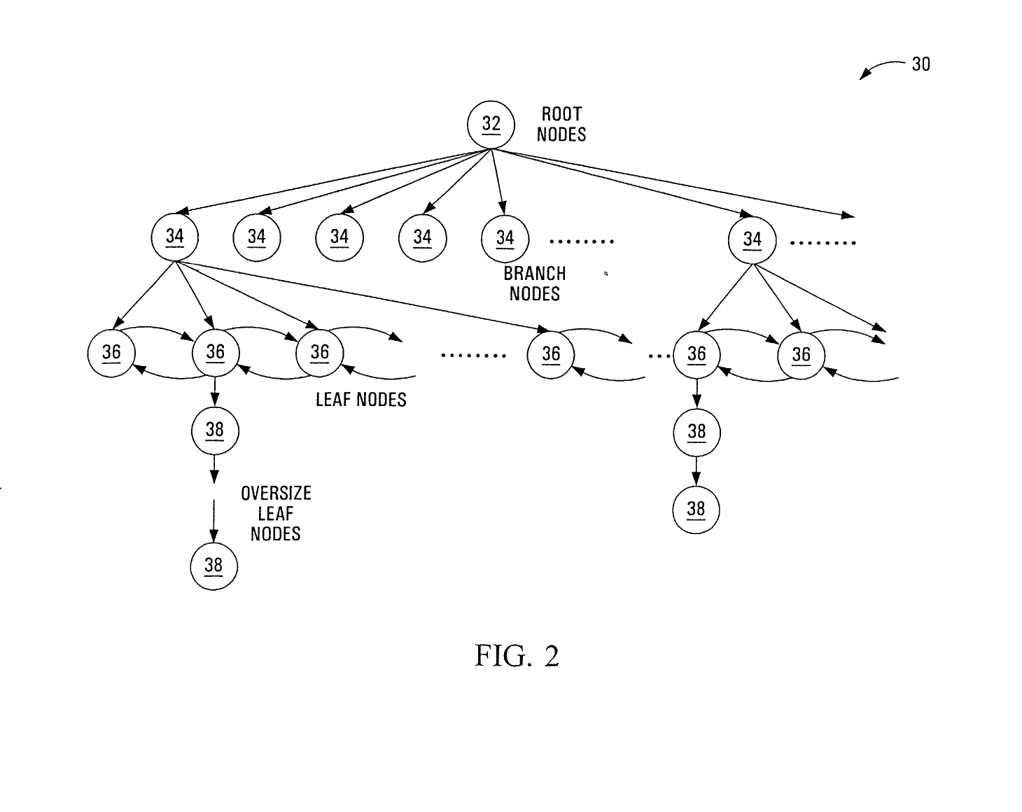

FIG. 2 illustrates the organization of a B-Tree 30, exemplary of an embodiment of the present invention. B-tree 30 is preferably used to index source code cross-referencing information. However, B-Tree 30 may be used to store and index wide variety of data. As will be appreciated, B-Tree 30 is a data structure containing data, and stored within memory 24 of computer 20. B-Tree 30 includes plurality of linked nodes, referred to as root node 32, branch nodes 34, and leaf nodes 36 and 38. Nodes 32, 34, 36 and 38 within B-tree 30 are linked to other nodes by pointers, as illustrated by arrows in FIG. 2.

Root node 32 is the top most node within B-tree 30. Branch nodes 34 are nodes that contain keys and pointers identifying leaf nodes 36 or other branch nodes 34 in a next lower level of tree 30. Finally, leaf nodes 36 contain records of data being indexed and pointers to adjacent leaf nodes 36 or to twin leaf nodes 38. As will become apparent, twin leaf nodes 38 are used to contain oversize data records that cannot be stored in a single leaf node 36.

Records of data stored within leaf nodes 36 include a key used to index the data, as well as the data itself.

B-tree 30 may have any size and is typically formed recursively. It is worth noting that if root node 32 is the only node in B-tree 30, it is a leaf node. Otherwise, it is a branch node. As will become apparent, for a formed B-tree 30 and exemplary of an embodiment of the invention, root node 32, and branch nodes 34 preferably only contain keys used to index data and corresponding pointers to other branch nodes 34 and leaf nodes 36. Records of the actual data to be stored in B-tree 30 are contained in leaf nodes 36 and twin leaf nodes 38.

B-tree 30 is organized to allow easy location and retrieval of records containing data within leaf nodes 36 and twin leaf nodes 38. Pointers stored within linked nodes of B-tree 30 may be followed, and B-tree 30 may be traversed to retrieve records contained within leaf nodes 36 or 38.

Specifically, as will be understood by those of ordinary skill in the art, for a properly organized B-tree h nodes in height, exactly h nodes will be traversed in order to access any leaf node 36, and therefore a record within the node.

Further, B-Tree 30 is referred to as a tree of order m and has the following Additional traits. Each branch node 34 points to m or fewer nodes (referred to as “sons” of the node) beneath it. Every node, except the root node 32, preferably has more than m/2 sons. Root node 32 has at least two sons, unless it is itself a leaf node, in which case it has no sons. So conveniently, for example, when m=256, B-tree 30 may contain up 16 million entries, with any entry accessible by traversing only 3 nodes.

For reasons that will become apparent, a branch node 34 with k sons contains k-1 keys. Each key preferably corresponds to a key used to index a record within one of nodes 36. Each key within a branch node 34 identifies the smallest key in a node beneath the branch node (ie. a son of the branch node). Each of the keys in the branch node is associated with a pointer also stored in the branch node and pointing to a node beneath the branch node containing the identified key.

Additionally, and conveniently, each of leaf nodes 36 contains pointers to adjacent leaf nodes 36. As will become apparent, these pointers facilitate traversing B-tree 30 and particularly searching for ranges of keys within the B-tree 30. As adjacent leaf nodes 36 contain pointers to each other, and as only leaf nodes 36 contain data, B-tree 30 is often referred to as a “B+tree”.

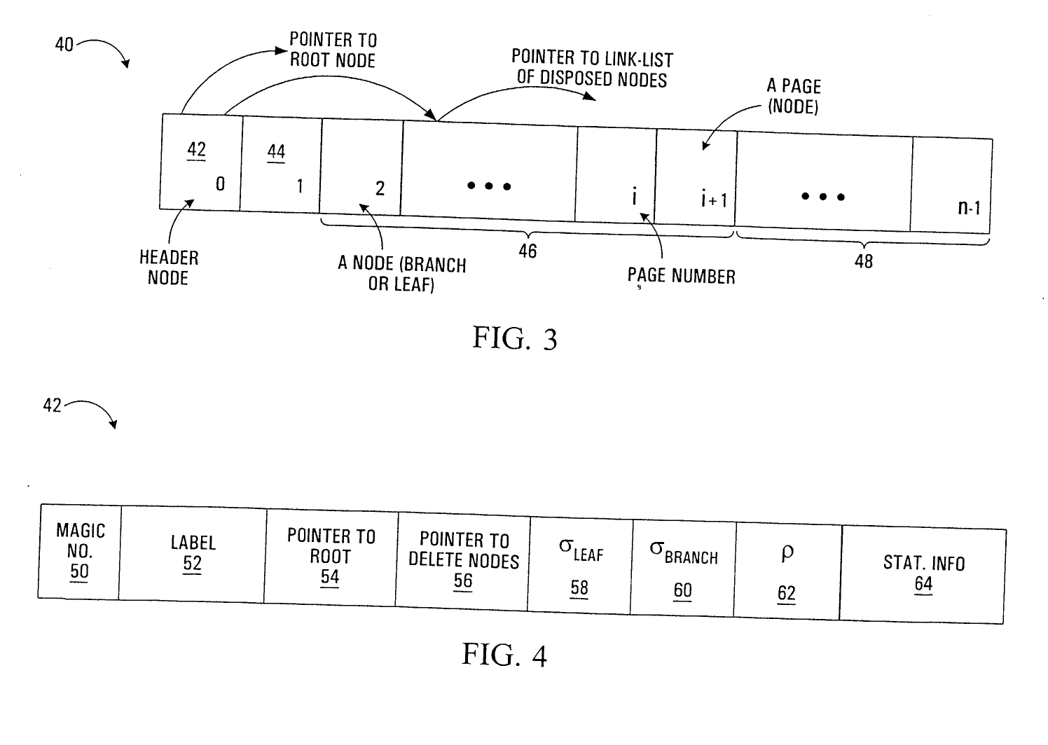

B-tree 30 may be stored in whole or in part in random access memory of computer 20 (FIG. 1). As well, B-tree 30 is preferably eventually stored within a file within a persistent memory portion of memory 24. An exemplary organization of such a file 40 is illustrated in FIG. 3 Each node 32, 34, 36 and 38 (FIG. 2) preferably occupies exactly one logical page within file 40. A page, of course, refers to the minimum number of contiguous bytes of data that a file handling system of an operating system reads or writes when accessing a file within memory 24. For a typical UNIX operating system, for example, the physical page size is 4096 bytes.

As illustrated, file 40 contains a header page 42, followed by a page 44 containing root node 32 (FIG. 2), pages 46 containing leaf or branch nodes 34, 36 or 38, and pages 48 containing deleted nodes. For reasons that will become apparent, deleted pages 48 may be interspersed between pages 46.

The organization of header page 42 is further illustrated in FIG. 4. As illustrated in FIGS. 3 and 4, header page 42 contains a magic number 50 that may be used to ensure file 40 is of a proper type; a label field 52, preferably containing an ASCII identifier of file 40; an identifier field 54 of the page number within file 40 of root node 32; an identifier field 56 of the page number of a first deleted node; fields 58 and 60 identifying preferred values for parameters σ_{leaf} and σ_{branch}, used to control the splitting of branch and leaf nodes 34 and 36 (FIG. 2) as detailed below; and field 62 containing a value ρ used to control rotation of records between adjacent nodes, as also detailed below. Additionally, fields 64 further contain statistical information about file 40, including the total number of nodes allocated, the number of leaf, branch, twin leaf, and deleted nodes; the number of keys; the number of records; and the number of levels in B-tree 30. Data within header page 42 preferably occupies a full page so that the nodes stored in remaining pages 44, 46 and 48 (FIG. 3) also start on page boundaries within file 40.

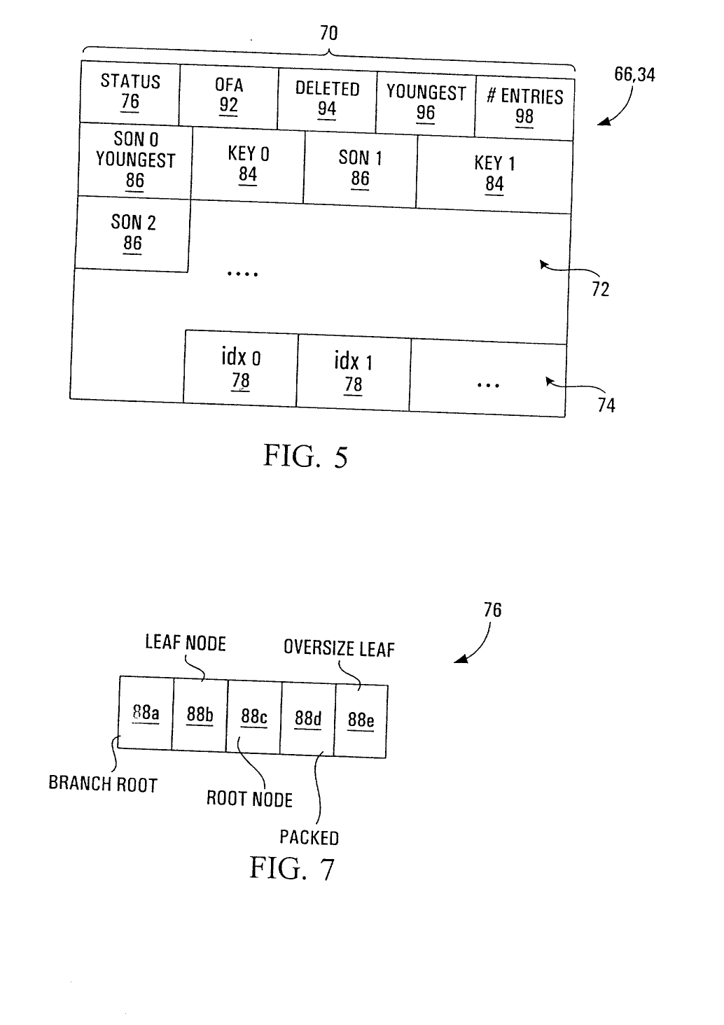

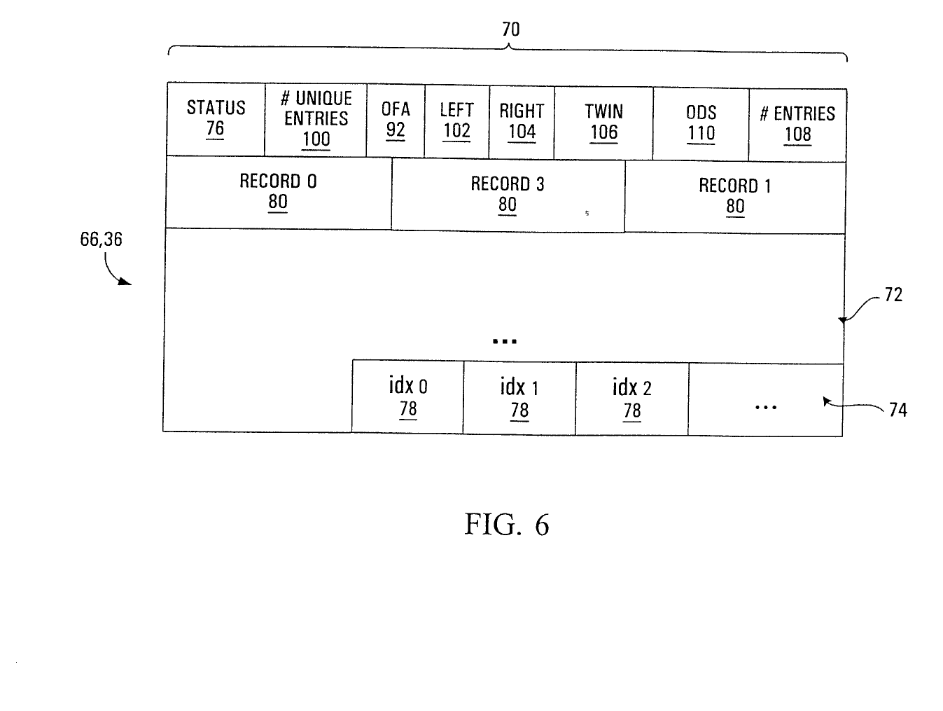

The format of the contents of nodes 32, 34, 36, and 38 (FIG. 1) (collectively referred to as data nodes 66) and corresponding pages of file 40 (FIG. 3) is illustrated in FIGS. 5 and 6. The format of the contents of branch nodes 34 is illustrated in FIG. 5; while the format of the contents of leaf nodes 36 is illustrated in FIG. 6.

As illustrated, each data node 66 includes its own header 70; followed by data area 72; followed by index area 74. Preferably, header 70; data area 72; and index area 74 are contiguous within node 66.

Header 70 contains a status field 76 including a bit pattern more particularly illustrated in FIG. 7, including bit 88a identifying a node as a branch node; flag 88b identifying a node as a leaf node; bit 88c identifying a node as a root node; bit 88d indicating whether or not a data node 56 is packed; and a bit 88e indicating whether or not the node is a twin leaf node.

As illustrated in FIG. 5, header 70 for each branch node 34 (FIG. 2) includes a status field 76; an offset to first available (“OFA”) field 92 identifying the first available byte within data space 72; a deleted records field 94, identifying the number of deleted keys within node 66; an identifier field 96, identifying the first son of the branch node; and field 98 identifying the number of entries within the node 66.

For branch node 34, data area 72 contains a plurality of keys 84, each followed by a pointer 86, identifying a son node within B-tree 30 (by page number within file 40 (FIG. 3)) having as its lexically smallest key, the key within data area 72 of the branch node 34. As well, a pointer to the left most son of each branch node is stored without a key in the branch node. Field 96 points to this pointer. Therefore, if a branch node has k sons, only k-1 pointers are stored.

As illustrated in FIG. 6, for each leaf node 36 header 70 further includes a field 100 identifying the number of unique key entries within the node 36; an OFA field 92 identifying an offset to the first available space in the data area 72; a field 108 identifying the total number of records within the node; a field 110 identifying the amount of unused space in an twin leaf node 38; an index field 102 identifying (by page number) an adjacent leaf node 36 within tree 30 to the left of node 66; an index field 104 identifying (by page number) an adjacent node within B-tree 30 to the right of node 66; a field 106 containing an index to a twin leaf node that is linked to the leaf node or to a twin leaf node 38 used to store the remainder of data in an oversize record. Optionally, adjacent branch nodes 34 (FIG. 5) could be similarly linked.

For leaf nodes 36, data area 72 contains a plurality of records 80, described in greater detail below.

Index area 74 (FIG. 6) for both branch nodes 34, leaf nodes 36, and twin leaf nodes 38 (FIG. 2) contains indices 78, that index records within these nodes by way of offsets within data area 72 to keys 84 within branch nodes 34, and records 80 within leaf nodes 36, respectively. Each index 78 preferably includes two words, one containing an offset from the start of data area 72 to a corresponding one of record 80 or key 84 within the node 66, the other containing an indicator of the length of that record 80 or that key 84 and associated pointer 86. In the event a record has been deleted, it is not indexed within index area 74.

As records are added to a node 66, index area 74 grows backwards (ie. toward the beginning of the node) within the node occupying space that might otherwise be occupied by data area 72. Similarly, data area 72 grows forwards (ie. away from the beginning of the node) within the node 66, occupying space that could otherwise be occupied by index area 74. Thus, as data area 72 and index area 74 are preferably contiguous, such growth of data area 72 and index area 74 allows for efficient use of space within node 66. The beginning of index 74 may determined by calculating an offset from the end of the node based on the number of records in the node in field 108 or 98, and the number of words used for each index.

Twin leaf nodes 38 are a special class of leaf nodes 36 and, as such, have the same format as leaf nodes 36, illustrated in FIG. 6. Twin leaf nodes and leaf nodes linked to twin leaf nodes are identified by status bit 88d of status field 76 of header 70 (FIGS. 6, 7). Each twin leaf node 38 is preferably linked from a leaf node 36 or other twin leaf node 38.

Twin nodes 38 preferably do not contain a complete header. Instead, the entire page of a twin node is used to store data, typically associated with a single record. A leaf node 36, to which a twin node 38 is linked preferably contains the offset to the first available space within the last twin node 38 linked to it. This offset may be used to insert additional duplicates within the twin node.

Field 106 identifies a twin leaf node linked from the leaf node. Leaf node 36 and those twin leaf nodes 38 linked to it form a linked list of leaf nodes. Because nodes 36 are stored in pages of fixed size, twin leaf nodes 38 store oversized records and/or records of the same key as records within a leaf node 36 which cannot fit into a single leaf node 36. Preferably oversize records always start within an otherwise blank leaf node 36 or otherwise blank twin leaf node 38. As a corollary, all nodes in a list of twin leaf nodes preferably contain records of the same key.

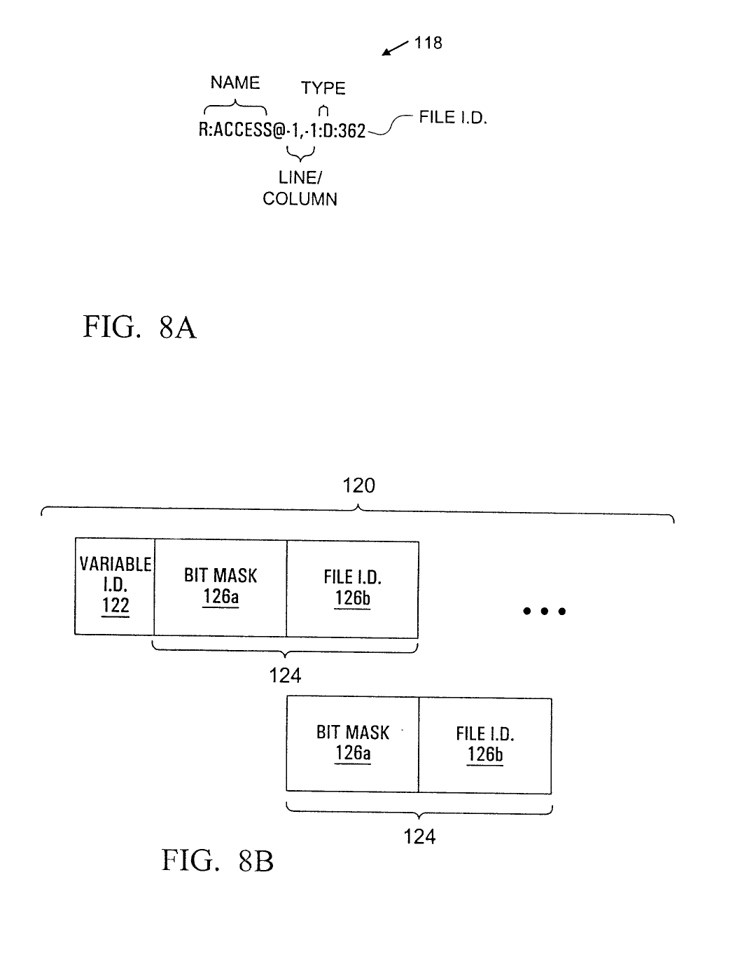

In operation, a complete B-tree 30 as illustrated in FIG. 2, is formed as a result of arranging data to be searchably organized. Most preferably, B-tree 30 is used to store global cross-referencing information used to index computer source code. Source code may, for example, be parsed using a conventional full text source code parser, such as one available from Edison Design Group of New Jersey. The parser preferably generates a flat cross-reference file 118 including global cross-referencing information. Each line within the flat cross-reference file preferably has the same format as illustrated in FIG. 8A. Each line preferably identifies a variable by name found in a group of source files, and information about each occurrence of a variable within the source code. As illustrated, the exemplary source code file 118 merely contains an identifier of the variable; its location within a source code file (by line and column, or by a defined value in the event of a global reference); the type of occurrence of the variable (ie. definition, invocation, etc.); and a file identifier. The type of occurrence, identifies how a variable is used. Multiple identifiers of occurrence types may be present in a single line. The file identifier may be a numerical identifier corresponding to a file within the source code in which the variable is located. A source code cross-referencing tool may build a mapping of actual file names to numerical identifiers. As will be appreciated, the numerical identifiers reduce the size of the formed file, as well as the size of the B-tree used to index the source code. In the line illustrated in FIG. 8A, the variable ACCESS, is identified as being defined globally in the file identified by numerical identifier 362. As illustrated, conventional, colon and other delimiters may be used to delimit fields within each line.

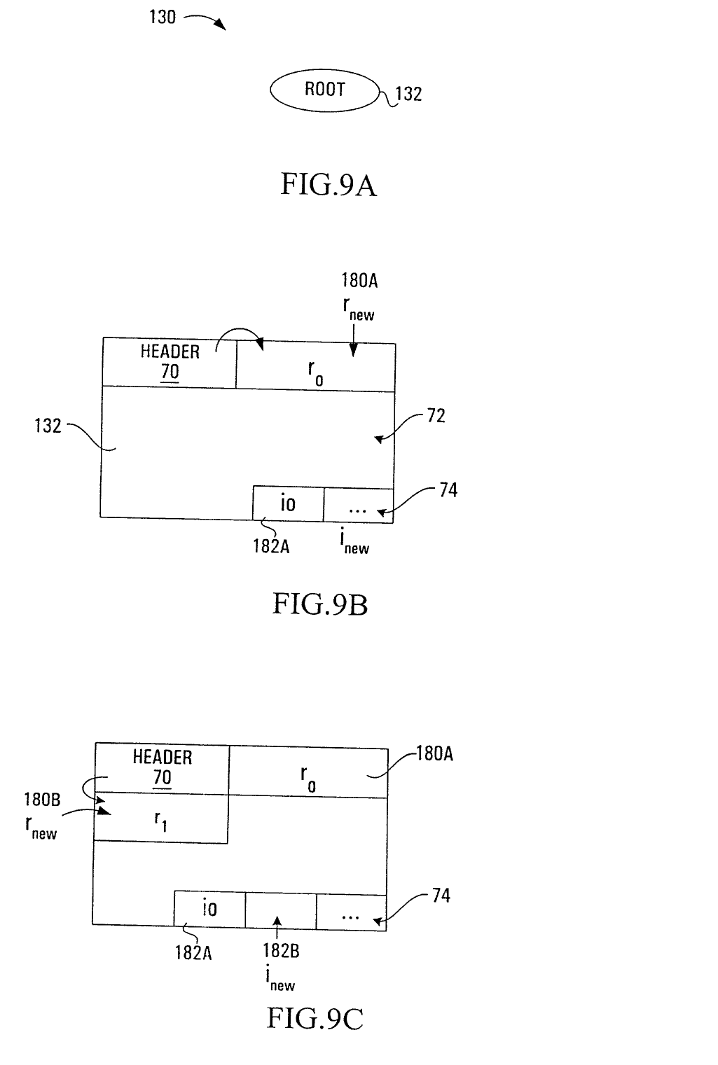

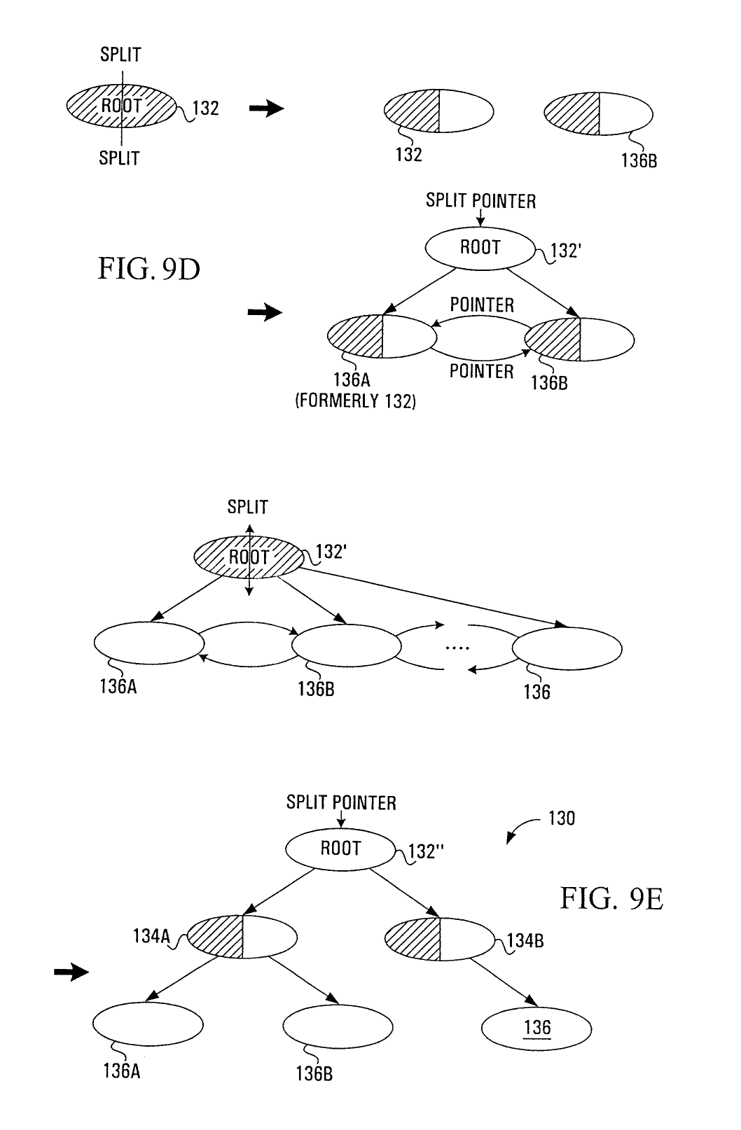

Information extracted from file 118 may now be inserted into a B-tree to form B-tree 30. A person skilled in the art will readily appreciate that other data may be similarly stored within B-tree 30. For convenience, the formation of B-tree 30 may better be understood with reference to FIGS. 9A-9E illustrating the formation of a B-tree 130, that may eventually be identical in structure and content to B-tree 30.

B-Tree 130 may be created by first forming a root node 132, illustrated in FIG. 9A. That is, a variable of a type defining root node 132 is initially created in memory. This variable is in the form of an data type having the structure of a page holding leaf node 34, as depicted in FIG. 6.

Next, a record to be added is formed. The format of a record 120 to be added is illustrated in FIG. 8B. As illustrated, a record to be added includes a variable identifier 122, followed by one or more token pairs 124. Variable identifier 122 to be indexed is formed by extracting the variable name from file 118 and “mangling” the variable name to form a unique key used to index a record within B-tree 130 and in order to ensure that this key has a length below a threshold. Each key indexes a variable within file 118, and a corresponding record within B-tree 130. After the key is formed, additional variable information may be appended to form a complete variable identifier stored within a leaf node. Preferably, a complete variable identifier has the format

<key>;<kind code><storage class><protection><basic type>;<name>;[<func type>] specific to the C++ programming language:

Where <kind code> is preferably a classification of the kind of symbol, and may be one of the following codes,

ke Language keyword;

ma Preprocessor macro;

co Constant (enumerator);

ty Typedef'd type;

Cs Tag of a struct, or C++ class type;

un Tag of a union, or C++ union type;

en Tag of an enumeration, or C++ enum type;

va Variable or parameter;

Fi Field (member) of a struct or union—in C++, a non-static data member;

st Static data member of a class;

me Member function of a class;

ro Function;

la Label in a function;

ud Undefined identifier;

ev Definition of a variable with external or internal

linkage, used to check that all definitions of a given external/internal name are equivalent;

er Definition of a routine with external or internal linkage;

pr Projection of a member symbol from a base class into a derived class;

ov C++ overloaded function (member or non-member);

pa Parameter name in a function prototype;

ct Definition of a C++ class template;

ft Definition of a C++ function template

ns Definition of a C++ namespace;

np Projection of a member of a namespace into another scope (either through a using-declaration or as a by-product of a lookup);

us Unknown symbol kind;

Where <storage> class may be one of the following codes:

ex External. This implies a reference to something defined in another compilation unit;

st Static;

au Local, stack-based. Includes parameters.

un No explicit storage class was given.

ty preferably used in variables or functions, but in this enumeration for convenience when scanning declarations;

re Register, a special case of local. Includes parameters declared “register”.

as An asm function.

lo Auto or static at back end's preference.

co A COMMON block;

ac, Variable is part of an association;

in, Intrinsic function or subroutine;

pb, Pointee of a POINTER definition;

Where <protection> is the C++ protection level code:

pc Public

pd Protected

pe Private

na Not accessible

If the name is not a member of a class/struct/union, then its protection level will preferably be public (pc)

<basic type> is preferably the name (if known or can be generated) of the type of the identifier. Typically this will be filled in for variables.

<function type> is preferably the parameter list if the symbol is a function.

Variable identifiers 122 so formed allow for fast filtering of large numbers of identifiers. Preferably, the key information is at the front of the complete variable identifier, and not “encoded” into the identifier as might be done. When an identifier 122 is read the key information may be stripped and appropriate filters may be used for each identifier that allow for very fast filtering without having to “demangle” every identifier.

Mangling techniques are more completely described in “The Annotated C++ Reference Manual”, Margaret A. Ellis, and Bjarne Stroustrup, Addison Wesley, 1994 ISBN 0-201-51459-1, the contents of which are hereby incorporated by reference.

The variable identifier is associated with one or more token pairs 124 illustrated in FIG. 8A. Each token pair preferably includes a two word token 126b identifying a file in the source code in which the variable of the record occurred, and a two word token 126a identifying how the variable is used in that file. Preferably, token 126b corresponds to the source code identifier in file 118 (FIG. 8A). As noted a source code file name to numerical token correspondence is maintained by a source code cross-referencing tool, and stored outside of B-tree 30.

The remaining token 126a preferably represents a bit mask describing how the variable identified by identifier 122 was used in the file identified by token 126b. Each bit describes a particular attribute of how a variable may be used. For example, the bit mask may be allocate bits as follows:

B0 ADDRESS,

B1 ALL_REF_CLASSES,

B2 BIND,

B3 BIND_AS,

B4 CAST,

B5 DATA_DEFINITION,

B6 DEFINITION,

B7 DERIVED,

B8 EXECUTE,

B9 IMPLEMENTATION,

B10 MISCELLANEOUS,

B11 NOT_SET,

B12 PROTOTYPE,

B13 PURE_VIRTUAL_PROTOTYPE,

B14 RAISE,

B15 READ,

B16 REFINEMENT,

B17 STATIC_INSTANCE,

B18 TYPE_DEFINITION,

B19 VIRTUAL_PROTOTYPE,

B20 WRITE

The remaining eleven bits need not be used, or could be used to describe other variable attributes. Use of such a bit mask in token 126a allows very quick filtering of large amounts of cross reference information. Optionally, each record 120 may contain multiple token pairs 124. Each token pair 124 may identify a different occurrence of the variable identified by identifier 122 within the source code. So, if flat file 118 is sorted prior to inserting records into tree 130, multiple occurrences of a single variable will be grouped and could be added to a single record. Single records including information about all occurrences of a particular variable may be formed and added to B-tree 130. Beneficially, then, this allows occurrences of variables to be inserted into B-tree 130, in groups, with all occurrence of a variable within file 110 inserted at the same time and in a single operation. This of course greatly speeds the formation of B-tree 130.

Interestingly, each record 120 preferably only includes global cross-referencing information, and does not include local cross-referencing information. Thus, information about the line and column occurrence of each variable within the source code is preferably not indexed within B-tree 130.

Once formed, a data record corresponding to the occurrence of the first variable within file 118 is inserted into the created root/leaf node 132, as illustrated in FIG. 9B. Specifically, a first index 182a is added within index area 74 at the end of root node 132; header 70 is used to locate the beginning of unused space within data area 72; and a data record 180a of the format of record 120 (FIG. 8B) is added to the beginning of data area 74. Index field 182a identifies the location of the record 180a, by an offset from the beginning of the data area 72, as well as the length of record 180a. Additionally, header 70 of root node 132 is updated to point to the next available byte within data area 72, as better illustrated in FIG. 9B.

In the event that the created record is greater than the capacity of root node 132, one or more additional twin leaf nodes of the format of nodes 38 would be created. Field 110 of header 70 of root node 132 would be updated to contain a link to the created twin leaf node.

After the initial record is inserted in the root node 132 of the newly formed B-tree 130, one or more subsequent records are inserted within root node 132, as illustrated in FIG. 9C. Specifically, field 92 (FIG. 6) of header 70 of node 132 is again used to locate a next available byte within data area 72 of root node 132 and the record to be inserted is added at this point within the data area 72. Thereafter an index 182b to the newly added record is added to index area 74. The index to the added record 182b is inserted after the index associated with the record having the next lexically smaller key. Indices representing records with a lexically smaller key than the inserted record, are moved to the left to make room for the inserted index. As a result, indices 182 are sorted to correspond in order to the lexical of keys of records 180 appearing within node 132. As will be appreciated, records stored within data area 72 may be of varying size. Header 70 is again updated so that its field 92 (FIG. 6) points to the first available byte within data area 72. Fields 100 and 108 (FIG. 6) are similarly updated to reflect the new number of entries and unique entries within the node.

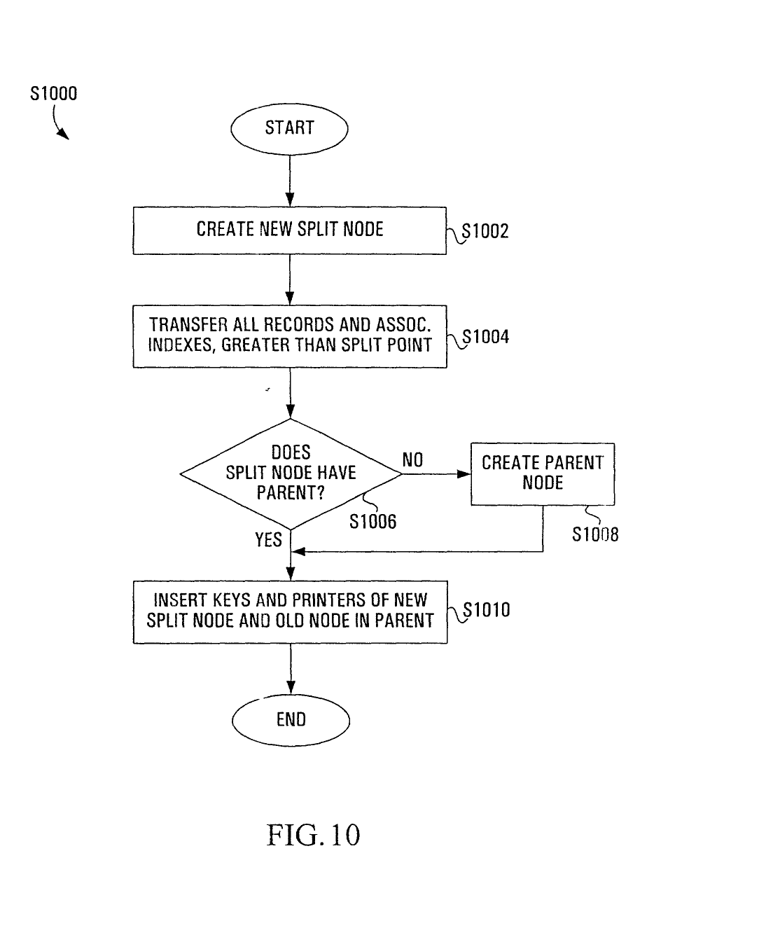

Once the root node 132 is full and can no longer accommodate additional data, the root node is split into two leaf nodes 136a and 136b, as illustrated in FIG. 9D and with reference to steps S1000 in FIG. 10. A new root (branch) node 132′ pointing to the two leaf nodes is created, as schematically illustrated in FIG. 9D.

First, a split point within the former root node 132 is chosen, as discussed below. A new split node (ie. leaf node 136b is created in step S1002. All records and associated indices in node 132 having keys with values greater than the split point are moved to the created node 136b in step S1004, while all records with keys having values less than or equal to the split point are retained within the former root node 132 (now considered a leaf node 136a). Next, a determination is made to determine if leaf nodes 136a and 136b have a parent node in step S1006. If not, a new parent node (ie a new root node 132′) is created in step S1008. Root node 132′ now becomes a parent of leaf nodes 136a and 136b. Now a key and pointer to the former root node 132 (now leaf node 136a) and the newly created leaf node 136b, are created and inserted into the parent node (ie newly created root node 132′) in step S1010. The keys inserted into the parent node (root node 132′) have the value of the smallest key within the associated leaf node 136a and 136b.

Thus, at the conclusion of step S1010, B-tree 30, has three nodes as illustrated in FIG. 9D. Additionally, fields 102 and 104 (FIG. 6) of header 70 of nodes 136a and 136b are updated to contain pointers to the adjacent nodes. Field 54 identifying the root node of B-tree 130 and fields 64 containing statistical information about B-tree 130 and file 40 may be updated.

Now, as will be appreciated, if the split point within root node 132 is chosen near the center of the root node 132, leaf nodes 136a and 136b contain about half as much data within their data area as root node 132, prior to the split, and the record to be inserted may be inserted in either leaf node 136a or 136b, as appropriate.

New records may be added to leaf nodes 136a and 136b, as with root node 132, described above. Of course, as the data is added, the leaf node to which the data is to be added is first located. This is performed by first forming the key for the data to be added and then using root node 132′ to locate which of nodes 136a and 136b, the new data record should be added. Once a leaf node 136a or 136b fills, it too may be split in accordance with steps S1000 illustrated in FIG. 10.

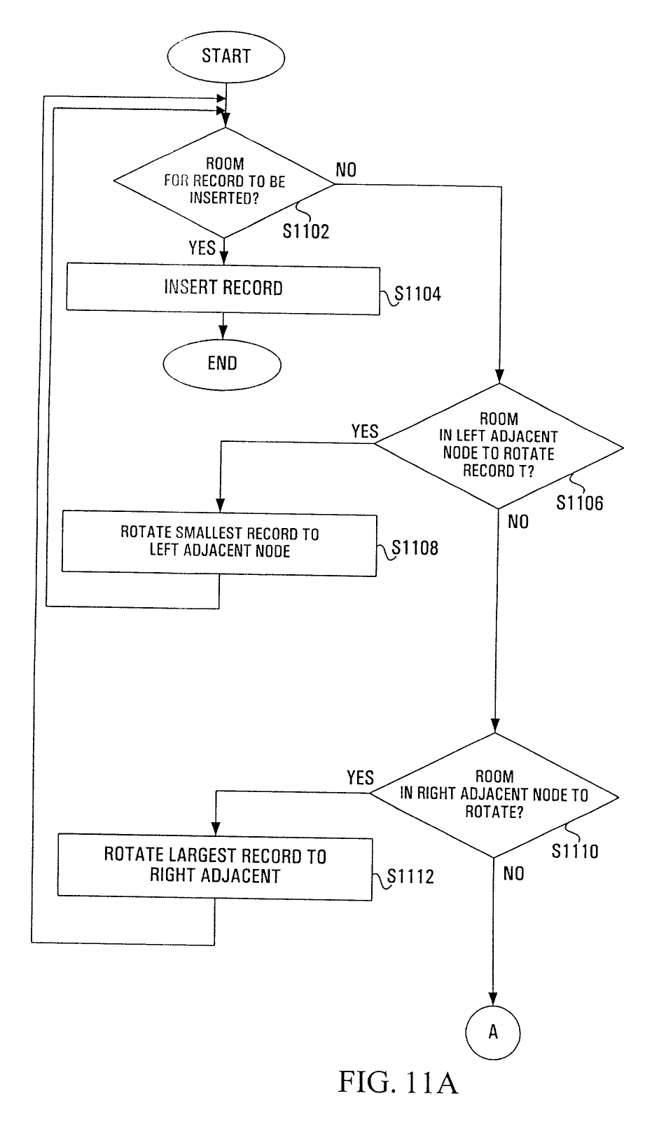

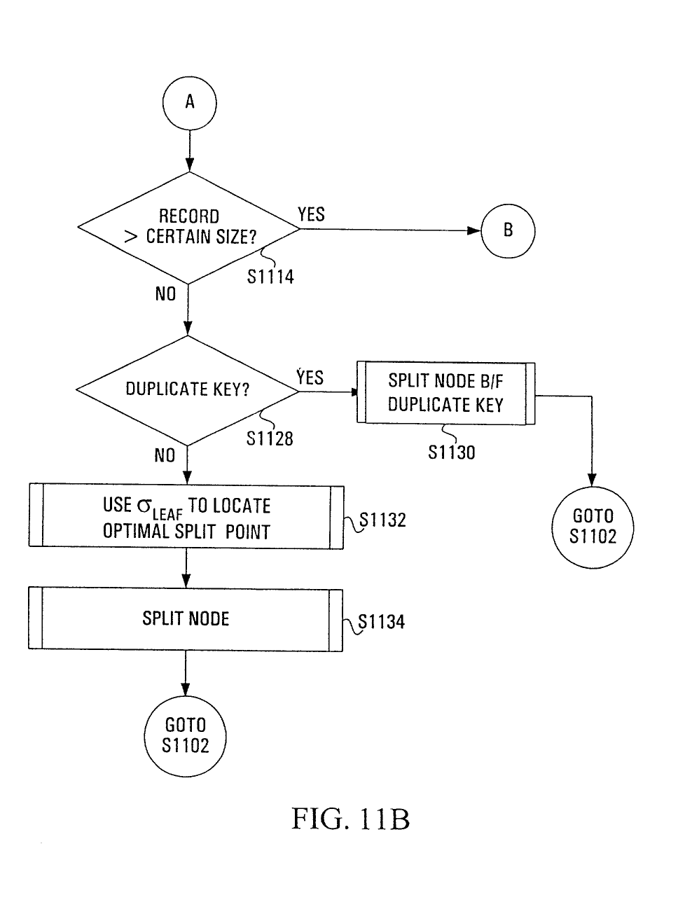

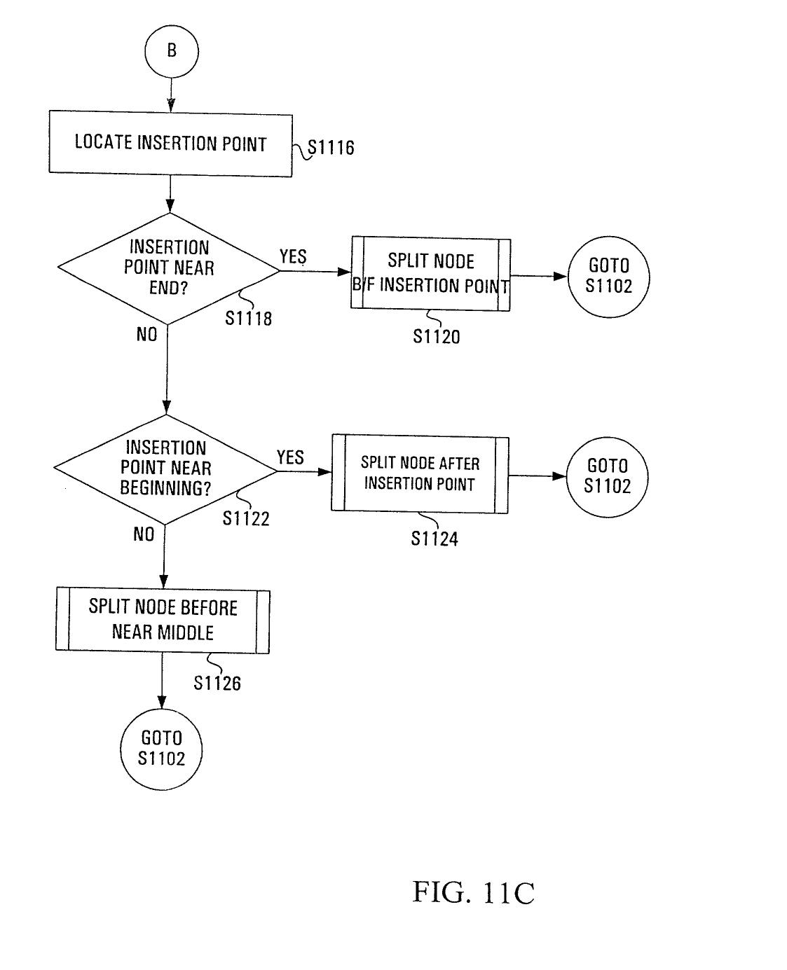

Steps S1100 performed in adding a data record to a leaf node 136a or 136b are more completely illustrated in FIGS. 11A-11C. Specifically, if room remains in the node to which data is to be added, as determined in step S1102, the record and corresponding index are inserted in step S1104, as detailed with reference to FIG. 9C.

If, however, the node is too full to accept the record to be added as determined in step S1102, the node is split or an existing record is rotated out of the node to make room, in steps S1106 et seq.

As illustrated, in order to prevent unnecessary splitting of records 136a and 136b, records within these adjacent nodes may be rotated between nodes in steps S1106 to S1112. Specifically, in the event a record is to be added to a leaf node 136a, but leaf node 136a is filled and space remains available in leaf node 136b, as determined in step S1106 the largest keyed record within node 136a is moved to leaf node 136b in step S1108, steps S1102 and on are repeated and the record is inserted in step S1104. In order to avoid rotation with little or no value, rotation of data between adjacent nodes is preferably only performed if an adjacent node has more than a threshold number of bytes of available space. Preferably, a record is only rotated to an adjacent node, if the adjacent node would have more than ρ bytes available, after rotation. The value of ρ is preferably stored in field 62 (FIG. 4) of header page 42. Similarly, if leaf node 136b fills before leaf node 136a, the smallest keyed record within node 136b is moved to leaf node 136a in step S1112, if space is available as determined in step S1110. As will be appreciated, if leaf node 136a or 136b had a second adjacent node (as, for example, in a larger tree), an attempt to rotate records to the right and left adjacent nodes would preferably be made in steps S1106-S1108 and S1110-S1112. Once an existing record has been rotated, the record to be inserted may be inserted by repeating steps S1102 and S1104. As records at the edge (ie. beginning or end) of the ordered records within nodes 136a and 136b are rotated, rotation does not affect the order of the records after rotation.

In the event record rotation is not possible, as determined in steps S1106 and S1110, a split location for a node may be determined and a leaf node may again be split in step S1120; S1124 or S1126, S1130, S1134 using steps S1000, described above. Again, root node 132′, as a parent of the split leaf node is updated to include a pointer to the split node.

Preferably, the split location within the leaf node to be split is determined based on the length and type of record to be inserted. That is, it has been realized that a node may not be fully used because it contains records of duplicate keys, or one big record, thereby not providing sufficient room to insert many new keys. In order to alleviate fragmentation problems caused by insertion of oversize records, or insertion of records of duplicate keys, heuristic rules are used to locate preferred split locations. Preferably, these rules allow large new records inserted into the tree to be inserted into their own nodes instead of being inserted into a twin leaf node. Once a twin leaf node is created, space within in it that is left unused after creation will typically not be used, and will be wasted. Therefore, these heuristic rules are preferably employed to ensure that, when practical, large records are provided stored in their own leaf node 136, without use of a twin leaf node of the format of node 38 (FIG. 2).

This is accomplished by choosing the split point within the node, at or near the insertion location of the record if no split were necessary. This adjusts which records will be copied in the split to ensure that large records end up in their own nodes.

So, if a record having a relatively large size as determined in step S1118 (preferably greater than one-half the fixed size of each node) is being inserted, steps S1114-S1126 may be performed to split the node. Specifically, once the node to which data is to be inserted is determined in step S1114, a location point based on the key associated with the node to be inserted, and the already existing keys within the node is determined. That is, the insertion location within the node is determined, as if no split of the node were necessary. If this insertion location is near the end of the node (preferably within one to three records from the end of the node), as determined in step S1118, a split point just before (preferably immediately before) the insertion location and the record is split in step S1120. Then, steps S1102, forward are repeated so that the new record will be added in step S1104. Hopefully then, the newly added node will be inserted into its own node.

If, on the other hand, the new record is to be inserted near the beginning of a node (preferably within approximately one to three records of the beginning of a node) as determined in step S1122, the split location is chosen just after (preferably immediately after) the insertion location in step S1124. Then, all records with keys lexically larger than that of the record to be inserted are moved to the newly created split node. The large record will hopefully fit into the node that has been emptied as a result of the split.

Similarly, if the new record is to be inserted near the middle of the node, as determined as a corollary in step S1126, the split location within the node is chosen just after (preferably the one record past the middle of the node) the middle of the node is chosen in step S1126; the node is split in accordance with steps S1000; and steps S1102 onward are repeated so that the record is inserted into the node created as a result of the split in step S1126. That is, the new large record and all the larger keyed records will be placed in this newly created node. As will be appreciated, this has minimal impact on the described problem - however, as the record is to be inserted near the middle of the node, only limited options are available.

Finally, if a key for the record being inserted and causing the split is already in the node, as determined in step S1128, the split location is chosen just before (preferably immediately before) the first entry of the duplicate key and the node is split in step S1130. This way, the duplicate node and the appended data is moved to its own node. Other non-duplicate records can preferably be handled more compactly within a node with fewer duplicates.

As will be appreciated, an attempted insertion of a record larger than the capacity of a node (ie. larger than a page) into a leaf node 36 already containing one or more records, will result in the splitting of the existing node to form another leaf node, linked to a twin leaf node.

In the event a record having a unique key and beneath the threshold size is to be inserted, as determined in steps S1114 and S1128, and leaf node 136 is to be split as a result, the value of σ_{leaf} stored in field 58 of page 42 is used to determine the split point within the node 136 to be split in step S1132. The σ_{leaf} value governs the number of keys around the midpoint of the node are to be evaluated as possible split points. Specifically, if σ=1, the split point will be chosen in the middle of the node to be split. So, if there are n records within the node to be split, the split point will be between ┌n/2┘ and┌n/2┘+1. If σ>1, keys will be determined for the adjacent records about the middle point of the node. For instance, when there are n records and with m=n/2 and σ=3, key m-1; key m; and key m+1 within the nodes are evaluated. The split point in the node may then be chosen based on the record identified by the shortest (ie. having the fewest characters) key. Then , the node is split in step S1134. Once the node is split, steps S1102 and on are repeated, so that a record may be added in step S1104.

Similarly, when branch nodes are split, the value of σ_{branch} is so used in splitting any branch nodes (such as branch nodes 34 in FIG. 1). Conveniently, choosing the record identified by the shortest key will often result in an increased number of branches of the tree. As will be appreciated, a broader B-tree is quicker to search as it will typically have less height, and may therefore be more easily traversed.

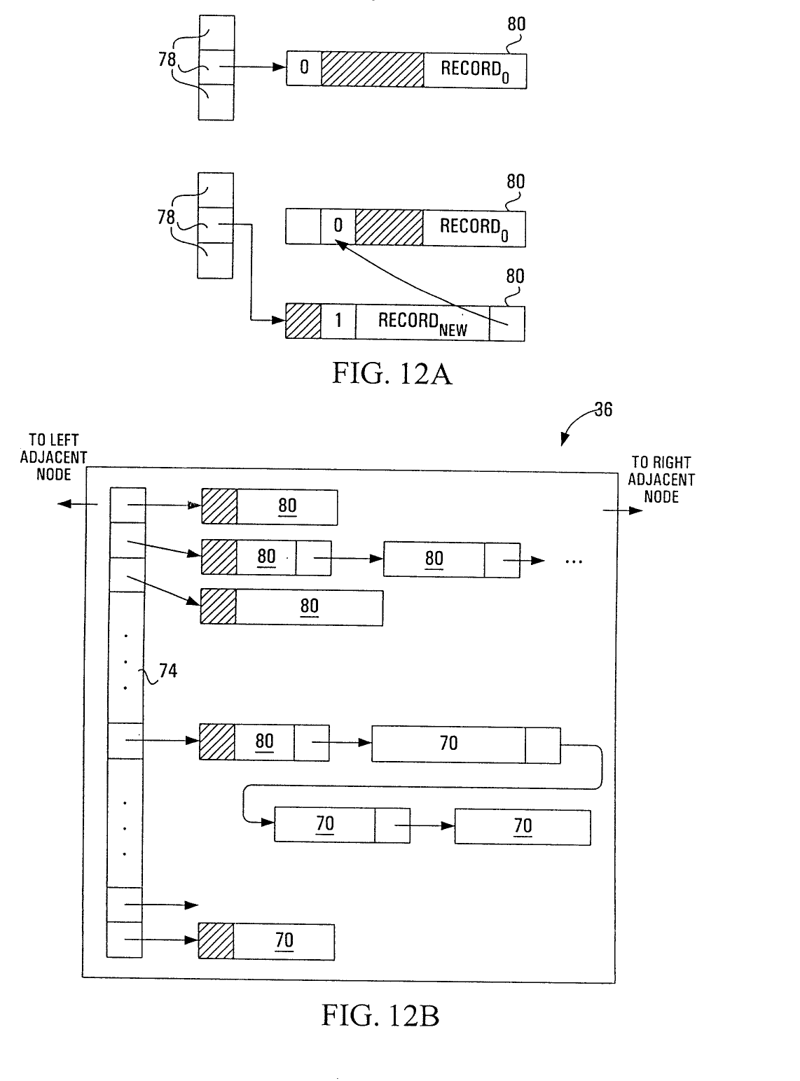

In the event the second or subsequent data record to be inserted into a leaf node has the same key as a record already present in the node, the new data record is stored as schematically illustrated in FIG. 12A and 12B. Specifically, all records 80 with the same key are preferably stored as a linked list. Newly added records are added at the beginning of the list, and an index to the previous first record in the list is added to the newly added record. As well, the key is deleted from the first record of the previous record. Similarly, the second record is updated to indicate that no data follows.

As will be appreciated, after splitting, root node 132′ remains a branch node, containing only pointers to leaf nodes 136a, and 136b. In the event root node 132′ fills, it too is split into branch nodes 134a and 134b, in a manner analagous to splitting of root node 132, detailed with reference to steps S1000 of FIG. 10. A new root node 132″ within B-tree 130 is created, thereby creating another level of branch nodes within B-tree 130, as illustrated in FIG. 9E. Again, newly created branch nodes 134a and 134b may be split as they fill with pointers to additional leaf nodes 136.

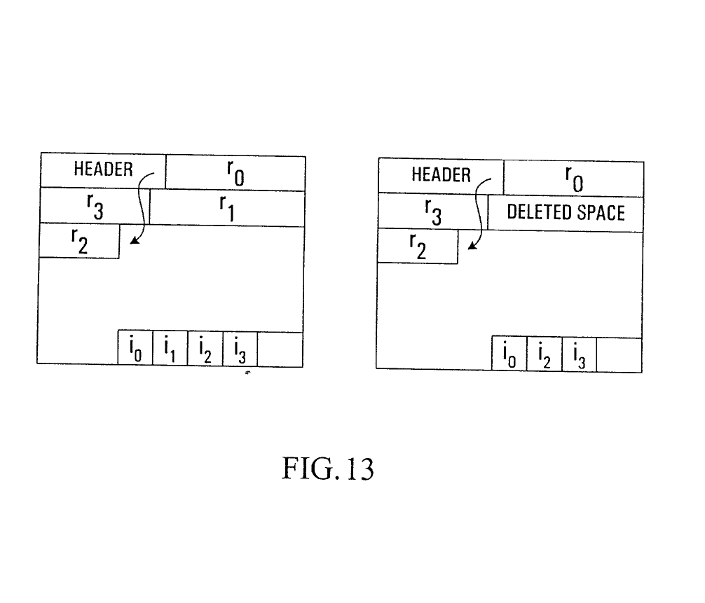

Records may also be deleted from leaf nodes 136a and 136b, as illustrated in FIG. 13. Specifically, as illustrated in the event illustrated record1 is to be deleted from an example node 136, only the index field for that record1 is deleted. The remaining index fields are shuffled to ensure that they are contiguously stored. As well, flag 88c within header 70 is updated to indicate that the node contains deleted records and is therefore no longer packed. A node may be packed on the next occasion that a record is to be inserted into the not-packed record; when a node is to be split; or when records within a node are to be rotated as described above. That is, prior to inserting a record, flag 88c of status field 76 of header 70 is checked to ensure that the node 136 is packed; if not, records within data area 74 may be re-arranged in a conventional manner to be contiguous.

In the event an entire page is deleted, it is typically not deleted from the file 40, storing B-tree 30. Instead, the deleted page is added to a linked list of deleted pages, by adding the deleted page to the beginning of an existing linked list of deleted page. The pointer to the existing list is stored within field 56, of header page 42 (FIG. 4). A pointer to the remaining deleted pages may be added to the in the newly added deleted node. Preferably, the first bytes of newly added deleted are modified to point to the next deleted node. Deleted pages may be re-used when new records are to be added to B-tree 20, by removing a deleted record form the linked list of deleted pages stored within pages 48. So, as will be appreciated pages 46 and 48 need not be contiguous.

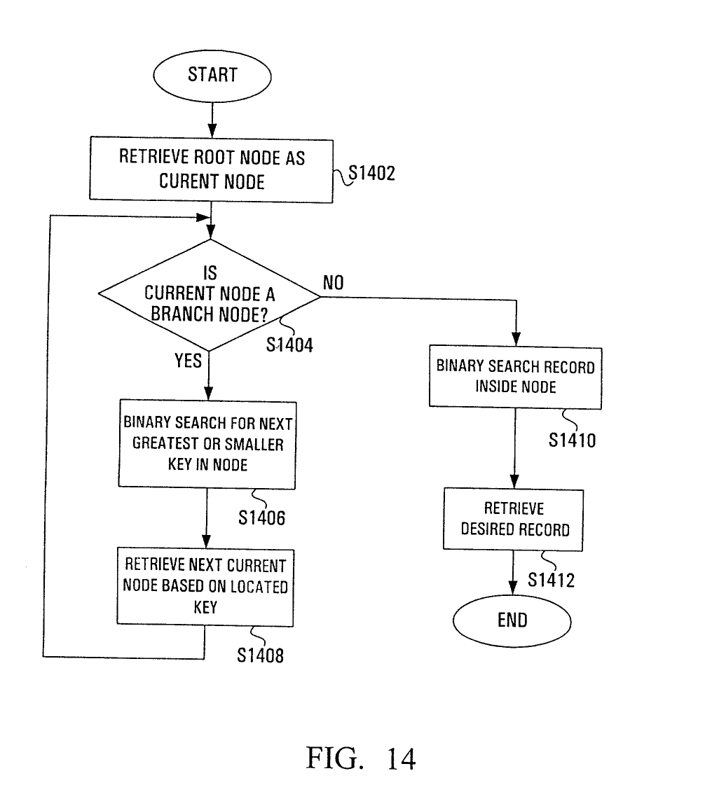

As will be appreciated, once B-tree 30 (FIG. 2) is wholly or partially formed (as illustrated with reference to FIGS. 9A-9E), any keyed record may be searched using the steps S1400 illustrated in FIG. 14. As illustrated, first root node 22 is retrieved as the current node in step S1402. If the current node is a branch node as determined in step S1404, a binary search on the indexes of the branch node may be performed to locate the next lexically greater or lesser key stored within the branch node in step S1406. If a larger or equal key is located, the son node to the right of the key is retrieved as the current node; otherwise the son node to the left of the key is retrieved as the current node. Steps S1404 and S1406 are repeated until the current node is a leaf node. Once the current node is a leaf node, a binary search is performed on the indices of that node in step S1410, until the desired record is located. Once the record is located, it and any twin leaf nodes may be retrieved in step S1412. In the event no record is located, a failure may be reported (not illustrated in FIG. 14).

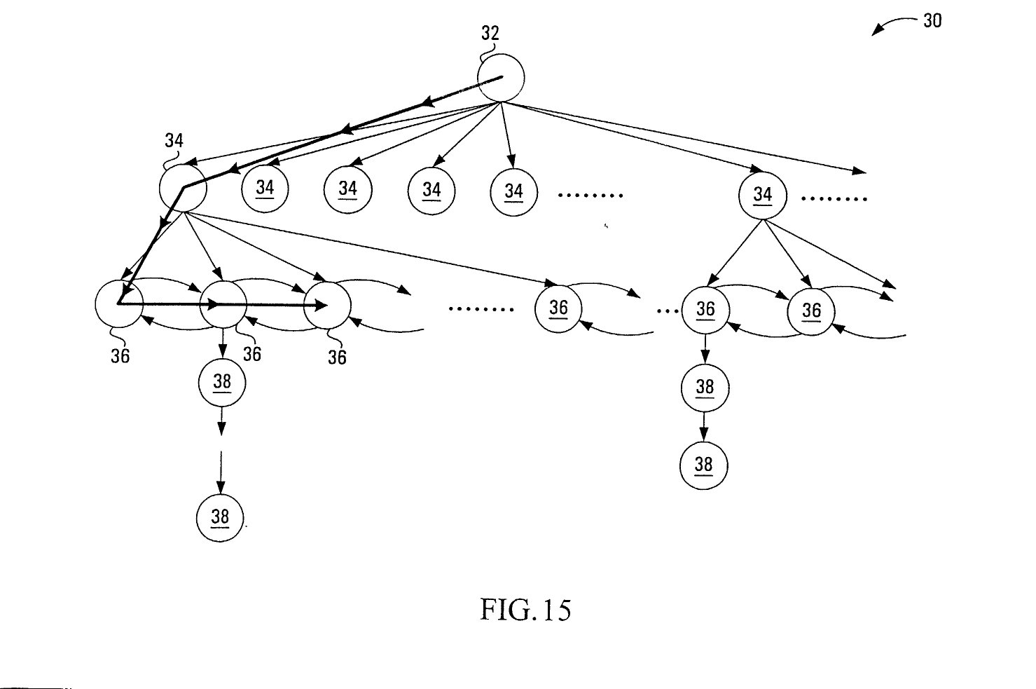

Alternatively, a B-tree may be traversed as illustrated in FIG. 15, by following the root node to the left most leaf node, and then following links to adjacent nodes, thereby traversing the B-tree in ascending order until a node containing the desired key is located. This node may then be searched using a binary search of indices 73. The tree may similarly be traversed in descending order by following the root node 32 to the right most leaf node, and then following adjoining leaf nodes, thereby traversing the tree in descending order.

Similarly, in the event a wild card search is conducted for records having keys within a range, steps used in FIG. 14 may be used to locate the node having the initial record within the range. Thereafter, records within the range may be extracted from the located node, and adjacent nodes using the links to the adjacent node.

Significantly, the ability to quickly search B-tree 30 in combination with bit masks describe with reference to FIG. 8B facilitates advanced source code analyses that are scalable. For example, a user may wish to locate all occurrences where a commonly used function is called, in the body of source code containing millions of lines of code. There may be tens of thousands of occurrence of the function. To expand (ie. extract, decode and display each occurrence from B-tree 30) each and every one of the occurrences immediately for the user would take a very long time, and not likely give provide useful information.

However, as B-tree 30 provides a global summary of where the files in which an identifier is referenced the query may be performed in two steps:

1. records may be extracted and using field 126b (FIG. 8B) the user may be given a list of all files containing the variable of interest; and

2. the user may select the files of interest and the corresponding records may be expanded.

Expansion step 2 may include extracting further information from the actual source code files identified by the user to he of interest. So, once files of interest are identified, further parsing could be performed in order to determine line and column occurrences of the identified variable within identified files.

Conveniently, once a plurality of files are identified a separate bit mask (not illustrated) representing the identified files may be formed. This bit mask may have a length corresponding to the total number of files within the source code. Each bit may be used to identify a single file. The position of each bit may correspond to the numerical value associated with a particular file. Bits identifying files of interest are set. The bit mask may be rotated to locate bits that are set. For each set bit, all occurrences of a variable of interest having a corresponding file identifier in field 126b may be expanded.

Similarly, bit mask 126a could be used to locate particular types of occurrences of a variable, within the source code.

The above described embodiments, are intended to be illustrative only and in no way limiting. The described embodiments of carrying out the invention, are susceptible to many modifications of form, size, arrangement of parts, and details of operation. The invention, rather, is intended to encompass all such modification within its scope, as defined by the claims.

The embodiments of the invention in which an exclusive property or privilege is claimed are defined as follows:

1. A method of adding a record to a leaf node of a B-tree having a plurality of leaf nodes storing data organized in records, with each of said leaf nodes containing at least one record, a corresponding number of indexes with each of said indexes indexing an associated record within said leaf node, and a pointer to at least one adjacent leaf node within said B-tree, said method comprising:
a. determining if an adjacent leaf node has sufficient space to accommodate an existing record from said leaf node;
b. if said adjacent leaf node has sufficient space, moving said existing record and index associated with said existing record from said leaf node to said adjacent leaf node, thereby increasing space for adding said record to said leaf node.

2. The method of claim 1, wherein a. and b. are performed only if said leaf node contains insufficient space for said record, prior to b.

3. The method of claim 1, wherein said existing record is only moved if said adjacent leaf node has more than a threshold of available space.

4. The method of claim 1, wherein records within each of said plurality of leaf nodes are ordered and records across adjacent ones of said plurality of leaf nodes are ordered, and
wherein said existing record comprises a record at an edge of said leaf node and said existing record is moved to an edge of said adjacent leaf node, so that records stored in said leaf nodes remain ordered after said existing record has been moved.

5. Computer readable memory storing a B-tree, said B-tree comprising a plurality of leaf nodes, each storing data in records, each of said leaf nodes comprising
a data area storing said records, and
an index area storing corresponding indices for said records within said data area, each index indexing one record within said data area,
wherein said records may be ordered by re-ordering said indices within said index area.

6. The computer readable memory of claim 5, wherein each of said leaf nodes has a fixed size, and said records are of variable size.

7. The computer readable memory of claim 6, wherein each of said indices further comprises an identifier of a length of a corresponding record.

8. The computer readable memory of claim 5, wherein said data area and said index area are contiguous and wherein said data area expands toward said index area as records are added to said data area, and said index area expands toward said data area as indices are added to said index area.

9. The computer readable medium of claim 5, wherein records within each of said leaf nodes are ordered and records across adjacent leaf nodes are ordered.

10. The computer readable medium of claim 9, wherein said indices are in order within said index area, thereby ordering said records.

11. The computer readable medium of claim 9, wherein each of said leaf nodes further comprises a pointer to an adjacent one of said leaf nodes.

12. The computer readable medium of claim 9, further comprising a pointer to a first available space within said data area.

13. The computer readable medium of claim 9, wherein a record within said node may be removed by removing an index corresponding to said record to be removed.

14. Computer readable memory storing a B-tree, said B-tree comprising
at least one leaf node storing data in records,
each of said records associated with a key,
wherein records associated with identical keys are stored as linked lists within said at least one leaf node.

15. The computer readable memory of claim 14, wherein said at least one leaf node further comprises an index to a first record within each of said linked lists.

16. The computer readable memory of claim 15, wherein said at least one leaf node has a fixed size.

17. The computer readable memory of claim 14, wherein said records have variable size.

18. A method of storing an oversize record in a B-tree, having leaf nodes of a maximum size for storing records, wherein said oversize record has a size in excess of said maximum size, comprising:
creating an additional node, linked to one of said leaf nodes and storing said oversize record at least partially in said one of said leaf nodes and said additional node.

19. The method of claim 18, wherein said additional node is linked to said one of said leaf nodes by a pointer to said additional node, stored in said one of said leaf nodes.

20. The method of claim 18, wherein each of said leaf nodes has a fixed size.

21. A method of splitting a leaf node within a B-tree storing records each associated with a key, in order to insert a record having a size in excess of a defined threshold, comprising:
assessing a plurality of split locations within a range of keys within said tree to locate a shortest length key within said range and splitting said node at said shortest length key.

22. A method of splitting a leaf node within a B-tree storing a plurality of ordered records, to insert an additional record having a size in excess of a defined threshold, at an insertion location within said node, comprising:
determining said insertion location within said node as if said node had capacity to store said additional record;
if said additional record is to be inserted near a beginning of said node, splitting said node after said insertion location to form two formed nodes, with one of said formed nodes containing all records in said node prior to said insertion location, and one of said formed nodes containing all records after said insertion location.

23. The method of claim 22, wherein said insertion location is determined so that said records remain ordered after insertion of said additional record.

24. A method of splitting a node within a B-tree, in order to insert a record having a size in excess of a defined threshold, at an insertion location within said node, comprising:
determining said insertion location within said node as if said node had capacity to store said additional record;
if said record is to be inserted near an end of a storage area within said node, splitting said node before said insertion location to form two formed nodes, with one of said formed nodes containing all records in said node prior to said insertion location, and one of said formed nodes containing all records after said insertion location.

25. A method of splitting a leaf node within a B-tree, having a data area storing a plurality of records, each of said records associated with a key, in order to insert a record associated with a particular key already associated with one of said records in said node, comprising:
splitting said node before a first record associated with said particular key to form two formed nodes, with one of said formed nodes containing all records in said node prior to said first record associated with said particular key, and one of said formed nodes containing all records after said insertion location, including all records associated with said particular key.

26. Computer readable medium storing computer executable software, adapting a computing device to split a leaf nodes within a B-tree stored at said computing device and comprising a plurality of leaf nodes storing data organized in records, with each of said leaf nodes containing a pointer to at least one adjacent leaf node within said tree, by:
a. determining if an adjacent leaf node has sufficient space to accommodate a record from said leaf node;
b. if said adjacent leaf node has sufficient space, moving an existing record from said leaf node to said adjacent leaf node, thereby increasing space for adding said record to said leaf node.

27. A method of forming a source code cross reference index for source code stored in at least one source code file, comprising:
for a variable used in said source code, forming at least one record, said record containing information about an occurrence of said variable within said source code;
storing said at least one record within a node of a B-tree.

28. The method of claim 27, wherein said record comprises a variable identifier identifying a name of said variable.

29. The method of 28, wherein said record comprises a file identifier of a file within said source containing an occurrence of said variable.

30. The method of 29, wherein said record comprises a bit mask identifying information about how said variable identified by said variable identifier is used in said file identified by said file identifier.

31. The method of claim 29, wherein said file identifier is a numerical identifier.

32. A software product for forming a source code cross reference index for source code stored in at least one source code file, comprising computer readable instructions adapting a computing device to
for a variable used in said source code, form at least one record, said record containing information about an occurrence of said variable within said source code;
store said at least one record within a node of a B-tree at said device.

33. Computer readable memory storing a B-tree, said B-tree comprising a plurality of leaf nodes, each storing data in records, each record containing information about an occurrence of a variable within a plurality of source code files.
